(19) United States
(12) Patent Application Publication
(10) Pub. No.: US 2026/0360262 A1
(43) Pub. Date: Nov. 12, 2026

(54) MOBILE PLATFORM DEPLOYMENT METHOD AND SYSTEM

(71) Applicant: Perennial Autonomy, LLC, Menlo Park, CA (US)

(72) Inventors: Michael Shane WILKERSON, Summerville, SC (US); Shawna MOORE, Mountain View, CA (US); Arya AZIZI, Los Gatos, CA (US); David SCHNELLE, Palo Alto, CA (US); Robert Donald VOCKE, III, San Jose, CA (US); Christian Johan Owen HANDLEY, San Francisco, CA (US)

(21) Appl. No.: 19/672,515

(22) Filed: May 8, 2026

Related U.S. Application Data
(63) Continuation-in-part of application No. 19/542,624, filed on Feb. 17, 2026.
(60) Provisional application No. 63/960,687, filed on Jan. 14, 2026.
(60) Provisional application No. 63/910,760, filed on Nov. 3, 2025.
(60) Provisional application No. 63/854,392, filed on Jul. 30, 2025.
(60) Provisional application No. 63/815,810, filed on Jun. 1, 2025.
(60) Provisional application No. 63/807,413, filed on May 16, 2025.
(60) Provisional application No. 63/803,081, filed on May 9, 2025.

(51) Int. Cl. G08G 5/57; B64F 1/36; B64U 20/80; B64U 80/30; B64U 80/40; B64U 80/70; G08G 5/22; G08G 5/26; G08G 5/52; B64U 101/64

(52) U.S. Cl. CPC G08G 5/57; B64F 1/36; B64U 20/80; B64U 80/30; B64U 80/40; B64U 80/70; G08G 5/22; G08G 5/26; G08G 5/52; B64U 2101/64; B64U 2201/20

(57) ABSTRACT

A system includes mobile platforms arranged in a stack. The mobile platforms include unique identifiers. The system includes a ground control station (GCS) configured to wirelessly communicate with the mobile platforms. The GCS is configured to receive identifier data from the mobile platforms within the stack, wherein the identifier data received from the mobile platforms comprises the unique identifier of an adjacent mobile platform within the stack. The GCS is configured to determine a stack order of the mobile platforms within the stack based on the received identifier data, determine a launch sequence of the mobile platforms based on the determined stack order, and implement a launch methodology based on the determined launch sequence.

### CROSS-REFERENCE TO RELATED APPLICATIONS

This non-provisional utility application claims priority to provisional patent application number 63/803,081, entitled “MOBILE PLATFORM DEPLOYMENT METHOD AND SYSTEM” and filed on May 9, 2025, provisional patent application number 63/807,413, entitled “LAUNCHING CONTAINER USING SUPPORTS FOR MOBILE PLATFORMS” and filed on May 16, 2025, provisional patent application number 63/815,810, entitled “LAUNCHING CONTAINER ASSEMBLY FOR MOBILE PLATFORMS” and filed on Jun. 1, 2025, provisional patent application number 63/854,392, entitled “DUAL-PURPOSE BOOT AND METHOD OF MANUFACTURE” and filed on Jul. 30, 2025, provisional patent application number 63/960,687, entitled “CONTAINER ASSEMBLY WITH SECURING MECHANISM” and filed on Jan. 14, 2026, provisional patent application number 63/910,760, entitled “MOBILE PLATFORM STACKING ASSEMBLY” and filed on Nov. 3, 2025, non-provisional patent application number 19/542,624, entitled “STACKING SPACER FOR MOBILE PLATFORMS” and filed on Feb. 17, 2026, each of which is incorporated herein in its entirety by reference.

### BACKGROUND

Existing methods and systems for deploying mobile platforms (e.g., rotor craft, fixed-wing, other uncrewed and/or autonomous aircraft, etc.) exhibit a variety of technical disadvantages.

### SUMMARY

In an aspect, a system includes mobile platforms arranged in a stack. The mobile platforms include unique identifiers. The system includes a ground control station (GCS) configured to wirelessly communicate with the mobile platforms. The GCS is configured to receive identifier data from the mobile platforms within the stack, wherein the identifier data received from the mobile platforms comprises the unique identifier of an adjacent mobile platform within the stack. The GCS is configured to determine a stack order of the mobile platforms within the stack based on the received identifier data, determine a launch sequence of the mobile platforms based on the determined stack order, and implement a launch methodology based on the determined launch sequence.

In another aspect, a method includes receiving identifier data from a mobile platform within a stack of mobile platforms, wherein the identifier data comprises a unique identifier of an adjacent mobile platform within the stack. The method includes determining a stack order of the mobile platforms within the stack based on the received identifier data, selecting a launch strategy based on the determined stack order, and launching the mobile platforms according to the selected launch strategy by dispatching mobile platforms from the stack in accordance with the determined stack order.

In another aspect, a method includes receiving, at a ground control station (GCS) in wireless communication with a plurality of stackable mobile platforms through a software defined radio (SDR) network, identifier data transmitted from cameras on the mobile platforms, with the identifier data corresponding to unique identifiers located on surfaces of adjacent mobile platforms within a stacked formation of the mobile platforms. The method includes analyzing the received identifier data utilizing the GCS to establish a sequence reflective of a stack order of the mobile platforms within the stacked formation, and updating the stack order utilizing the GCS based on at least one of newly received identifier data, a change in the stacked formation of the mobile platforms, an operational parameter, a payload delivery requirement, or a tactical deployment strategy.

### BRIEF DESCRIPTION OF THE DRAWINGS

FIG. 1 is a schematic view illustrating a mobile platform deployment system according to an implementation.

FIG. 2 is a perspective view illustrating a stack of mobile platforms according to an implementation.

FIG. 3 is a perspective view of a portion of the stack shown in FIG. 2 according to an implementation.

FIG. 4 is a perspective view of a portion of the stack shown in FIG. 2 according to an implementation.

FIG. 5 is a perspective view illustrating an example of a launching platform according to an implementation.

FIG. 6 illustrates elevational views of an example of the stack shown in FIG. 2 being held by an exemplary carrying pack according to an implementation.

FIG. 7 is a flowchart illustrating a method of operation of the system shown in FIG. 1 according to an implementation.

FIG. 8 is a flowchart illustrating a method of operation of the system shown in FIG. 1 according to an implementation.

FIG. 9 is a schematic diagram illustrating an exemplary operating environment of the disclosure according to an implementation.

### DETAILED DESCRIPTION

Existing methods and systems for deploying mobile platforms (e.g., rotor craft, fixed-wing, other uncrewed and/or autonomous aircraft, etc.) exhibit a variety of technical disadvantages. In one example, known methods and systems struggle to coordinate the deployment of a plurality of mobile platforms. For example, known methods and systems require manual input to organize, identify, and launch a group of mobile platforms in an orderly sequence. The manual intervention required by existing methods and systems is labor-intensive, may cause inefficiencies and/or delays, may limit operational flexibility, and/or the like. For example, manually determining the stack order of the mobile platforms and manual reconfiguration are examples of manual operations that limit the flexibility of existing methods and systems. Another example of the challenges faced by existing methods and systems is that known methods and systems struggle to integrate heterogeneous payload configurations, for example without extensive adjustments or interventions.

In contrast, aspects of the disclosure provide systems and methods for the organization, identification, and launch of stacked mobile platforms (e.g., from a launching platform). Aspects of the disclosure include mobile platforms with unique identifiers (e.g., quick response (QR) codes, near-field communication (NFC) tags, bar codes, etc.) positioned to be readable (e.g., by adjacent mobile platforms within the same stack). The unique identifiers enable a ground control station (GCS) to ascertain the stack order of a stack of mobile platforms and to manage the launch sequence of the stack. In some examples, the GCS interfaces with the mobile platforms through a software-defined radio network that facilitates local and/or remote communication. Aspects of the disclosure incorporate programmable strategies, for example enabling more rapid sequential releases, individually controlled launches, and/or adaptation to changing parameters. In some examples, payloads are configurable with variable types indicated on the unique identifiers, for example enhancing inventory management and operational planning. Aspects of the disclosure enable stackability with different mobile platform configurations without requiring electrical modifications, for example increasing operational efficiency and flexibility across a variety of deployment scenarios. The systems and methods disclosed herein enhance operational efficiency, adaptability, and effectiveness across a variety of operational scenarios and diverse industrial, commercial, and/or tactical requirements.

Aspects of the disclosure are operable in a range of applications including, but not limited to, logistics and delivery, agriculture, remote sensing and environmental monitoring, security and surveillance, search and rescue, disaster response and humanitarian aid, and/or the like.

For example, in logistics and delivery, aspects of the disclosure enable more efficient deployment of mobile platforms for parcel delivery, for example enabling more rapid dispatch and real-time reconfiguration of delivery routes based on the payload carried by each mobile platform. In some examples, the capability for multiple mobile platforms to be launched in a predetermined sequence reduces turnaround time, for example enhancing delivery efficiency.

In an agricultural example, the system is utilized for crop surveillance and monitoring. For example, multiple mobile platforms equipped with sensors are deployed more rapidly to capture and assess (e.g., relatively large, remote, etc.) areas of farmland, for example providing data within shorter timeframes and/or enabling more timely interventions based on the collected information.

Remote sensing and/or environmental monitoring examples include deploying mobile platforms with remote sensing equipment across (e.g., relatively expansive, etc.) geographic areas. In some examples, aspects of the disclosure enable monitoring changes in land use, assessing environmental impacts, and/or conducting relatively large-scale ecological surveys. In one example, aspects of the disclosure enable a group of mobile platforms to more efficiently survey areas of interest, for example, for pollution levels, ecosystem health, wildlife tracking, and/or the like.

In security and surveillance applications, for example in the security and defense industries, aspects of the disclosure enable a more organized and swifter deployment of mobile platforms in coordinated operations. For example, the ability to launch mobile platforms in relatively rapid succession and/or in a staggered formation (e.g., based on operational requirements, etc.) enable more comprehensive coverage of target areas, for example improving situational awareness and response times.

Search and rescue operation examples include dispatching mobile platforms to span wider areas, for example reducing the time needed to locate and provide assistance to individuals in distress. The versatility in payload configuration of aspects of the disclosure enables mobile platforms to be equipped with specific tools and/or supplies required for various rescue scenarios. Moreover, for disaster response and humanitarian aid, examples include delivering equipment, medical supplies, communication devices, and/or the like to affected areas, for example providing timelier and/or effective assistance in crisis situations.

Aspects of the disclosure operate in an unconventional manner at least by providing a system that includes mobile platforms arranged in a stack. The mobile platforms include unique identifiers. The system includes a GCS configured to wirelessly communicate with the mobile platforms. The GCS is configured to receive identifier data from the mobile platforms within the stack, wherein the identifier data received from the mobile platforms comprises the unique identifier of an adjacent mobile platform within the stack. The GCS is configured to determine a stack order of the mobile platforms within the stack based on the received identifier data, determine a launch sequence of the mobile platforms based on the determined stack order, and implement a launch methodology based on the determined launch sequence.

Aspects of the disclosure operate in an unconventional manner at least by providinga method that includes receiving identifier data from a mobile platform within a stack of mobile platforms, wherein the identifier data comprises a unique identifier of an adjacent mobile platform within the stack. The method includes determining a stack order of the mobile platforms within the stack based on the received identifier data, selecting a launch strategy based on the determined stack order, and launching the mobile platforms according to the selected launch strategy by dispatching mobile platforms from the stack in accordance with the determined stack order.

Aspects of the disclosure operate in an unconventional manner at least by providinga method that includes receiving, at a GCS in wireless communication with a plurality of stackable mobile platforms through a software defined radio (SDR) network, identifier data transmitted from cameras on the mobile platforms, with the identifier data corresponding to unique identifiers located on surfaces of adjacent mobile platforms within a stacked formation of the mobile platforms. The method includes analyzing the received identifier data utilizing the GCS to establish a sequence reflective of a stack order of the mobile platforms within the stacked formation, and updating the stack order utilizing the GCS based on at least one of newly received identifier data, a change in the stacked formation of the mobile platforms, an operational parameter, a payload delivery requirement, or a tactical deployment strategy.

Example technical solutions to the technical problems described herein include implementing unique identifiers, such as QR codes and/or NFC tags, on each mobile platform within a stack, for example providing the technical effect of enabling automated identification and organization. In some examples, aspects of the disclosure provide the technical solution of the unique identifiers being readable by cameras of adjacent mobile platforms, for example providing the technical effect of enabling the determination of stack order without manual intervention. Aspects of the disclosure provide the technical solution of a GCS that acts as a centralized control mechanism that interfaces wirelessly with the mobile platforms, for example utilizing an SDR network. Aspects of the disclosure provide the technical effects of enabling dynamic control over the launch sequence and reconfiguration capabilities based on specific operational requirements.

The technical solutions provided by aspects of the disclosure include launch methodology that supports multiple launch strategies (e.g., sequential launches, individual launches, etc.). The non-electrical identification system solutions provided by aspects of the disclosure provide the technical solution of enabling the integration of various payload types, which provides the technical effect of fostering greater operational versatility without the need for electrical modifications to the payload, camera, or physical structure of the mobile platforms or any support structure for the stack.

The technical effects of the disclosed methods and systems include providing improved mobile platform deployment processes. For example, aspects of the disclosure provide automated stack identification that enhances deployment efficiency by eliminating manual sequencing, thereby enabling more rapid operational readiness. Moreover, and for example, the GCS's ability to manage launches via a flexible, programmable network enables adaptability to various mission demands while maintaining communication. In some examples, the incorporation of non-electrical identifiers minimizes electromagnetic interference and enables customizable payload operations, for example improving inventory management and logistical planning. Aspects of the disclosure provide a more robust and adaptable deployment system capable of meeting diverse tactical and strategic objectives with increased agility and reduced resource dependency. Aspects of the disclosure enable more precise and controlled deployment of mobile platforms, for example tailored to the operational or environmental parameters.

Some aspects of the disclosure provide the ability to manage and identify mobile platforms based solely on non-electrical identifiers, such as QR codes and/or NFC tags, thus providing increased flexibility and reduced electromagnetic interference during deployment operations. In some examples, aspects of the disclosure integrate payload configurability directly within the non-electrical identifiers, for example enabling a variety of payload types across uniform structural units. In contrast, existing systems typically utilize additional electronic modifications and/or separate management practices, which can increase electromagnetic interference and require additional resources, thereby reducing efficiency.

Examples of mobile platforms (e.g., mobile platform 106, etc.) include, but are not limited to, uncrewed vehicles, uncrewed aerial vehicles (UAVs), aircraft (e.g., rotorcraft, fixed wing aircraft, airplanes, gliders, lighter-than-air craft, balloons, high-altitude balloons, UAVs, etc.), ground vehicles (e.g., land vehicles, automobiles, trucks, cars, electric vehicles, etc.), uncrewed ground vehicles (UGVs), aquatic vehicles (e.g., boats, ships, marine vehicles, freshwater vehicles, etc.), surface vehicles, submersibles, uncrewed aquatic vehicles, uncrewed marine vehicles (UMVs), uncrewed surface and/or submersible vehicles (USVs), space-based platforms, suborbital vehicles, vehicles that operate in orbit, platforms carried by an individual (e.g., a backpack and/or other carrying pack, etc.), missiles, rockets, uncrewed mobile platforms, autonomous mobile platforms, and/or the like. As used herein, one or more of the systems disclosed herein may be used onboard a mobile platform while the mobile platform is moving and/or while the mobile platform is stationary. In some examples, one or more of the systems disclosed herein is used with (e.g., onboard, onboard control, remote from, remote control, etc.) one or more uncrewed, autonomous platforms.

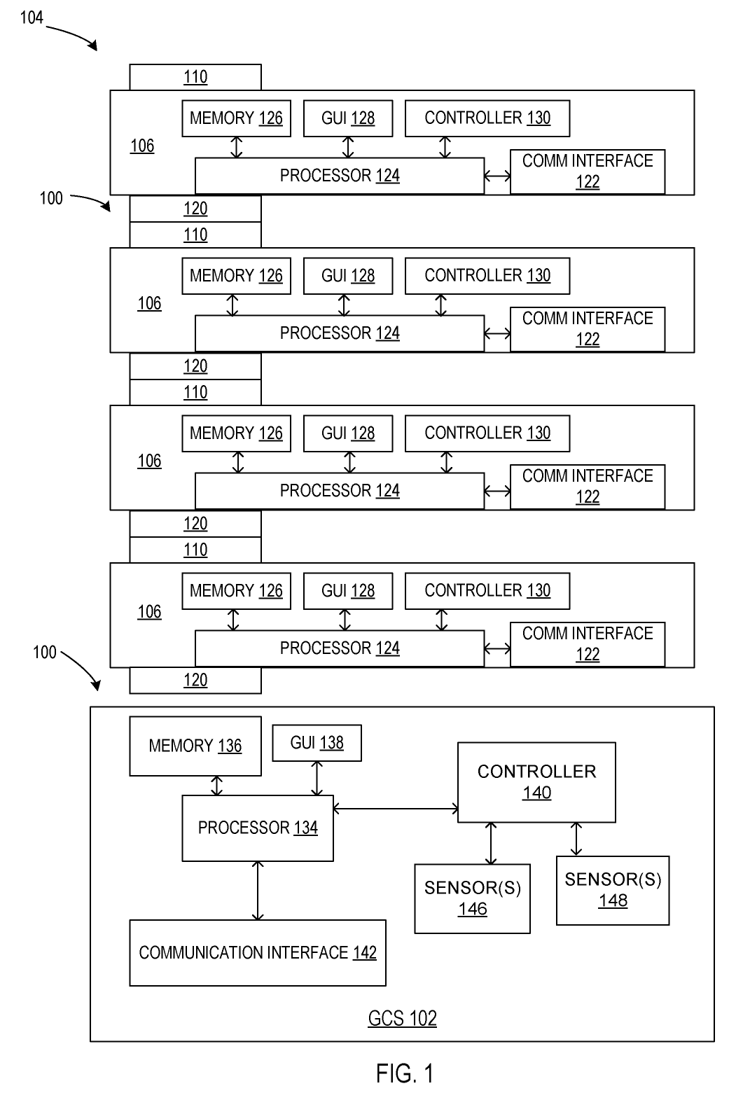

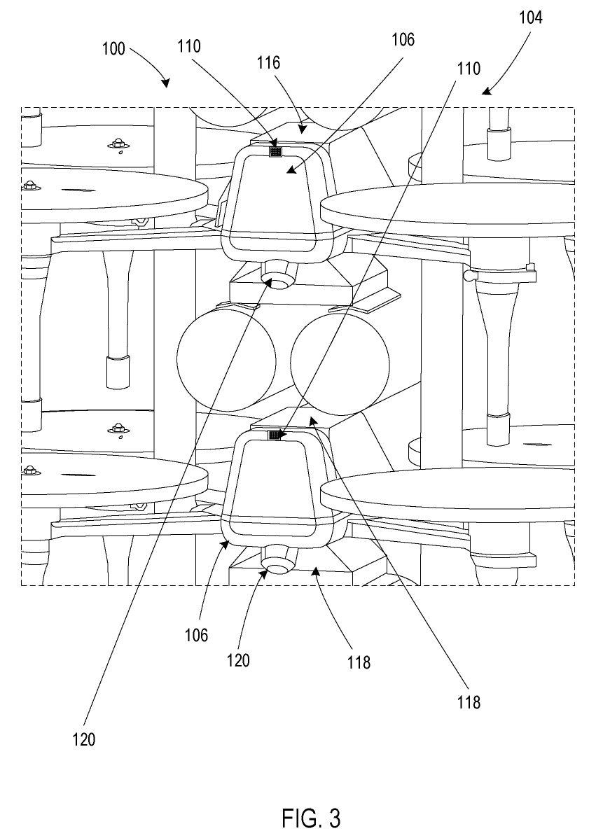

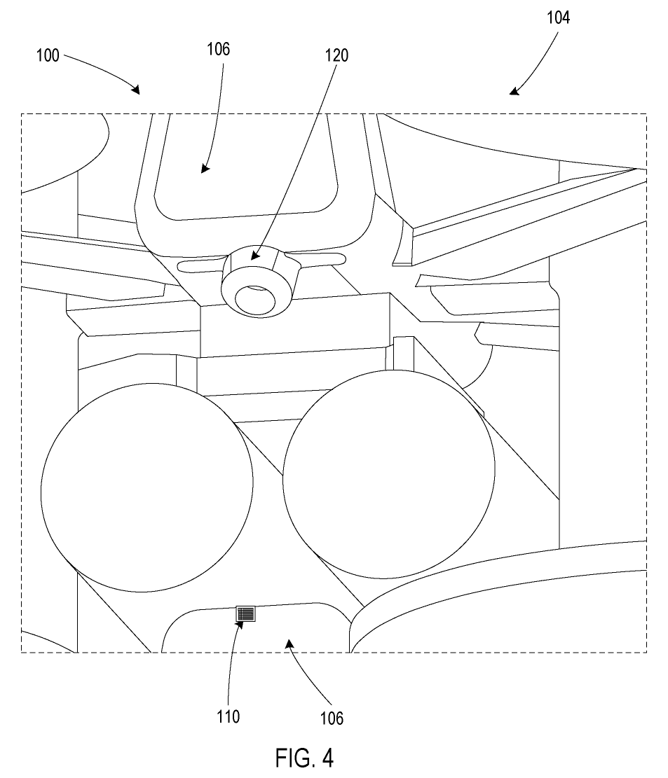

Referring to the figures, FIGS. 1-4 illustrate a mobile platform deployment system 100. The system 100 includes a GCS 102 and one or more stacks 104 of mobile platforms 106. In some examples, the stack 104 of the mobile platforms 106 is stored (e.g., within a building, container, and/or other structure; within a vehicle; within a cave and/or other underground area; outside; etc.) for later use. In some examples, the stack 104 is loaded onto another mobile platform (e.g., a vehicle, a mothership, a backpack and/or other carrying pack, a human, an animal, etc.) and transported to another location, for example for deployment of one or more of the mobile platforms 106 at the other location. Each stack 104 may include any number of mobile platforms 106. The system 100 may include any number of the stacks 104.

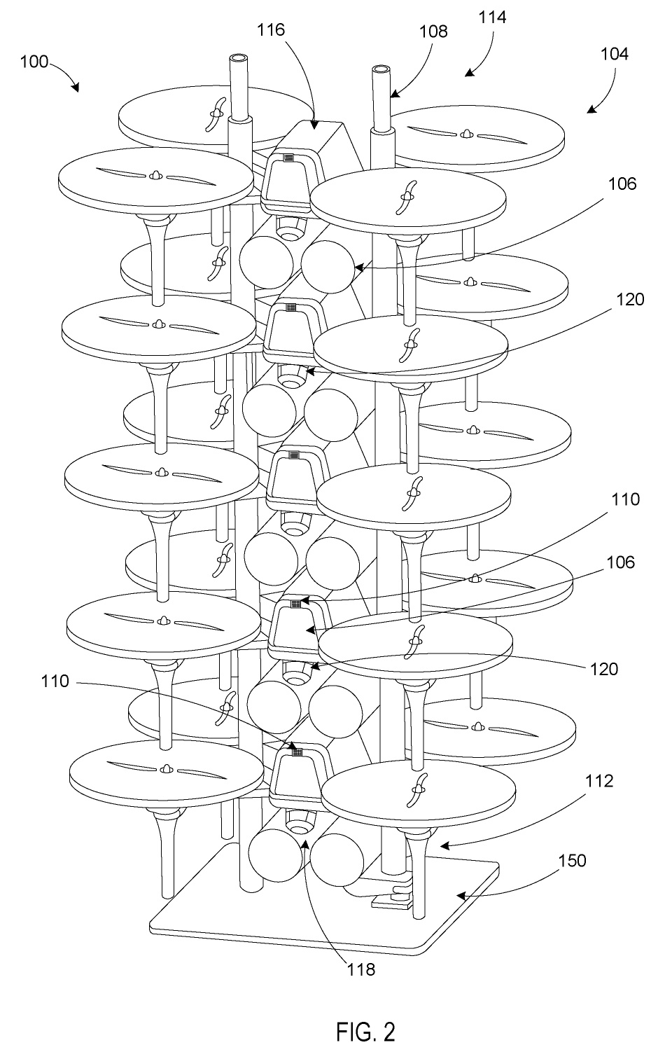

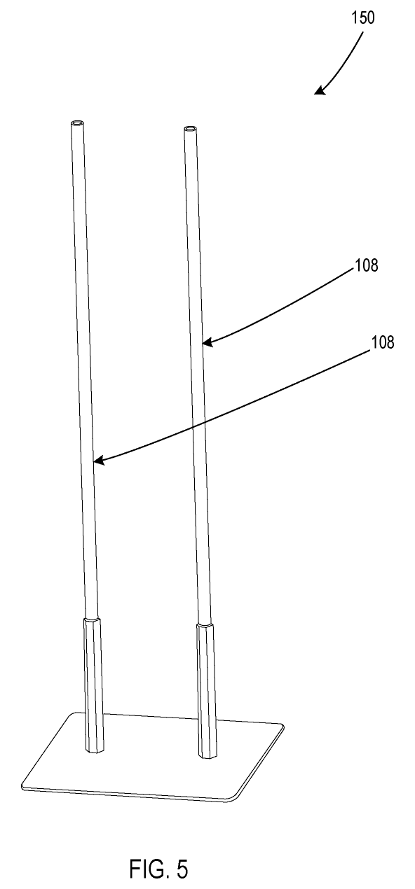

As will be described below, the mobile platforms 106 can be deployed (e.g., launched, etc.) directly from the stack 104. For example, a mobile platform 106 may deploy directly from the stack 104 by moving, under its own power, off a guide element (e.g., the guide rods 108 shown in FIGS. 2 and 5, etc.). In an exemplary implementation wherein the mobile platforms 106 are UAVs, the mobile platforms 106 may deploy directly from the stack 104 by flying off the guide rod 108 under their own power. In some examples, direct deployment of a mobile platform 106 is assisted by facilitating (e.g., initiating, boosting, replacing, etc.) the acceleration of the mobile platform 106 off the guide rod(s) 108, for example by spring loading the mobile platform 106, using a linear motor device (e.g., a rail gun, etc.), using a catapult (e.g., a steam catapult, a mechanical catapult, etc.), and/or the like. In some examples, the mobile platforms 106 can be deployed directly from the stack 104 while the stack is on another mobile platform that is moving.

In some examples, one or more of the mobile platforms 106 is removed from the stack before being deployed, for example manually, automatically, autonomously, and/or the like.

Although shown in FIGS. 1-4 as being stacked generally vertically with respect to the ground and/or other surface on which the stack 104 rests (e.g., a launching platform 150, another launching platform, etc.), the stack 104 may rest on the ground and/or other surface with any other orientation. For example, the stack 104 may be generally horizontal with respect to the ground and/or other surface, at an oblique angle with respect to the ground and/or other surface (e.g., the mobile platforms 106 deploy from the stack 104 at an approximately 45-degree angle, at an angle greater than 45 degrees, at an angle of less than 45 degrees, etc.).

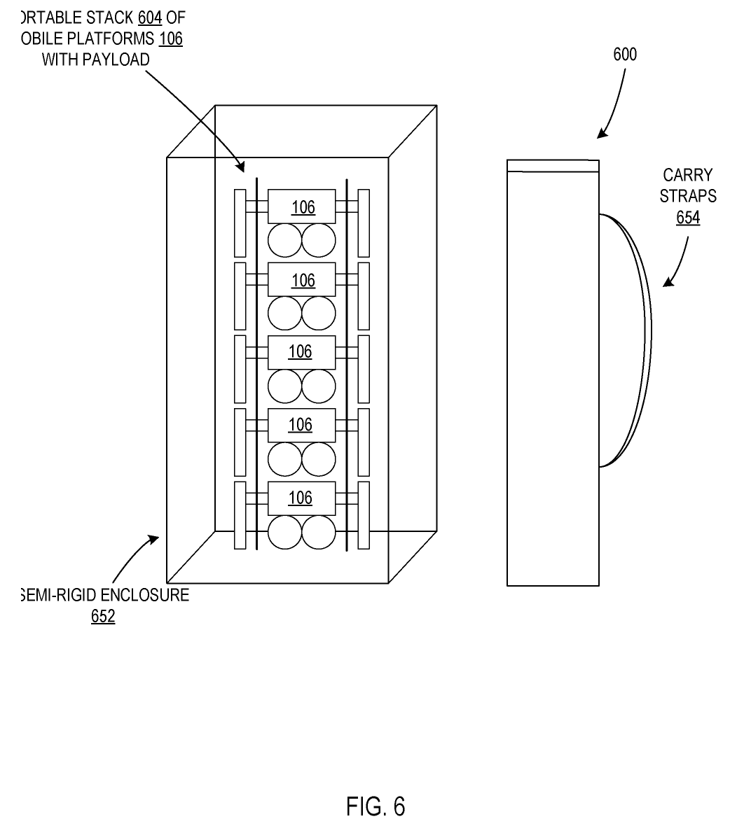

FIGS. 1-4 and 6 illustrate non-limiting examples of stacks 104 and 604, respectively, of the mobile platforms 106. The stack 604 shown in FIG. 6 is an example of a stack of the mobile platforms 106 being held by a carrying pack 600. For example, the carrying pack 600 may include an enclosure 652 that holds the stack 604 of the mobile platforms 106. In some examples, the carrying pack 600 is capable of being carried by an animal and/or a human individual. Optionally, the enclosure 652 includes a construction that is semi-rigid, rigid, soft, flexible, and/or the like. The carrying pack 600 optionally includes a carrying strap 654. In some examples, the carrying pack 600 is configured to be mounted to and/or within another mobile platform (e.g., a car, a truck, a boat, etc.).

FIG. 5 illustrates a non-limiting example of the launching platform 150. Although two are shown, the stack 104 may include any number of the guide rods 108 and/or other guide elements (e.g., guide elements having additional and/or alternative geometry as compared to the guide rods 108, etc.).

The mobile platforms 106 include identifier data that includes unique identifiers 110. For example, each mobile platform 106 is equipped with the unique identifier 110 that identifies the corresponding mobile platform 106. Although any other unique identifiers may additionally or alternatively be used, in some examples the unique identifiers 110 include machine-readable codes, linear barcodes, matrix barcodes, quick response (QR) codes, near-field communication (NFC) tags, and/or the like. Optionally, the identifier data of one or more of the mobile platforms 106 includes other data, such as, but not limited to, payload data, mobile platform system data, and/or the like. Payload data corresponds to a payload (not shown) that is optionally carried by the corresponding mobile platform 106. In some examples, payload data includes, but is not limited to, a payload delivery parameter, a payload delivery requirement, a deployment parameter, a payload type, a payload configuration, a deployment strategy, and/or the like.

The identifier data of each mobile platform 106 may be defined by any number of discrete segments and may be formed by any suitable structure, configuration, means, and/or the like. For example, the identifier data may be formed by: one or more decals applied to the corresponding mobile platform 106, one or more etchings within the corresponding mobile platform 106, one or more raised surfaces on the corresponding mobile platform 106, paint, another marking (e.g., pencil, pen, etc.), and/or the like.

The identifier data (including the unique identifier 110) of each mobile platform 106 is positioned on the corresponding mobile platform 106 such that the identifier data, and thus the unique identifier 110, is readable by at least one mobile platform 106 that is adjacent to the corresponding mobile platform 106 within the stack 104. As used herein in some examples, “adjacent” refers to below the corresponding mobile platform 106 within the stack 104 or above the corresponding mobile platform 106 within the stack 104. As used herein, a mobile platform 106 that is below another mobile platform 106 in the stack 104 is located closer to a base 112 (e.g., a bottom, etc.) of the stack 104, regardless of the orientation of the stack 104 relative to the ground and/or other surface on which the stack 104 rests. Similarly, a mobile platform 106 that is above another mobile platform 106 in the stack 104 is located closer to a free end 114 (e.g., a top, etc.) of the stack 104, regardless of the orientation of the stack 104 relative to the ground and/or other surface on which the stack 104 rests. The mobile platforms 106 are deployed from the stack 104 by moving off the free end 114 of the stack 104. In some examples, the base 112 of the stack 104 is labeled (e.g., with a decal, etching, paint, another marking, and/or the like, etc.). In a side launch configuration, adjacent mobile platforms are side-by-side.

In some examples, the unique identifier 110 is located on an upper portion 116 of the corresponding mobile platform 106. As shown herein, the upper portion 116 of the corresponding mobile platform 106 generally faces the adjacent mobile platform 106 that is above the corresponding mobile platform 106 in the stack 104. The location of the unique identifier on the upper portion 116 of the corresponding mobile platform 106 enables the unique identifier to be read by the adjacent mobile platform 106 that is above the corresponding mobile platform 106 of the stack 104. However, the unique identifier 110 of each mobile platform 106 may additionally or alternatively include any other location on the corresponding mobile platform 106 that enables the identifier data to be read by an adjacent mobile platform 106 in the stack 104, such as, but not limited to, on a lower portion 118 and/or a side of the corresponding mobile platform 106.

The mobile platforms 106 include readers 120 that are configured to read the identifier data (including the unique identifiers 110, the payload data, mobile platform system data, etc.) of adjacent mobile platforms 106 within the stack 104. Although any reader that is capable of reading the identifier data of an adjacent mobile platform 106 may be used, in some examples the readers 120 include cameras, machine-readable code readers, machine-readable tag readers (e.g., to read passive or active NFC tags), and/or the like. Each mobile platform 106 may include any number of the readers 120.

The reader(s) 120 of each mobile platform 106 is positioned on the corresponding mobile platform 106 such that the reader 120 is configured to read the identifier data of at least one mobile platform 106 that is adjacent the corresponding mobile platform 106 within the stack 104 (e.g., below the corresponding mobile platform 106 within the stack 104, above the corresponding mobile platform 106 within the stack 104, beside the corresponding mobile platform 106 within the stack 104, etc.). In some examples, the reader 120 is located on the lower portion 118 of the corresponding mobile platform 106 such that the reader 120 generally faces downward relative to the stack 104, for example as is shown in FIGS. 1-4. As the lower portion 118 of the corresponding mobile platform 106 generally faces the adjacent mobile platform 106 that is below the corresponding mobile platform 106 in the stack 104, the location of the reader 120 on the lower portion 118 of the corresponding mobile platform 106 enables the reader 120 to read the identifier data of the adjacent mobile platform 106 that is below the corresponding mobile platform 106 of the stack 104. However, the reader(s) 120 of each mobile platform 106 may additionally or alternatively include any other location on the corresponding mobile platform 106 that enables the reader 120 to read identifier data of an adjacent mobile platform 106 in the stack 104, such as, but not limited to, on the upper portion 116 and/or a side of the corresponding mobile platform 106. In some examples, the reader 120 of a mobile platform 106 is configured to read the identifier data of both adjacent mobile platforms 106 within the stack. As used herein, a reader 120 generally faces downward relative to the stack 104 when the reader 120 generally faces toward the base 112 of the stack 104, regardless of the orientation of the stack 104 relative to the ground and/or other surface on which the stack 104 rests.

Referring to FIG. 1, each mobile platform 106 includes a communications interface 122, for example for communicating with the GCS 102. For example, the communications interface 122 includes a network and/or other communication link for communicating over wireless communication protocols, such as, but not limited to, local area networks (LANs), wide area networks (WANs), Bluetooth, radio frequency, software defined radio (SDR), line-of-sight communication, relay-based communication, relay-based line-of-sight communication, Wi-Fi, long range (LoRa), long range wide area network (LoRaWAN), cellular networks, and/or the like. In some examples, to provide radio connections between the mobile platforms 106 and the GCS 102, the communications interface 122 includes one or more of: a mesh radio; a radio operating at approximately 2.4 GHz; a mini mesh radio; a LoRa antenna; an omni-directional antenna (e.g., an HGV-2404U 2.4 GHz omni-direction antenna, etc.); an antenna operating at approximately 2.4 GHz; a dual polarization antenna; a multiple-input multiple-output (MIMO) antenna (e.g., a 2.4 GHz Dual Polarization MIMO panel antenna, etc.); a MIMO panel antenna; and/or the like.

In some examples, one or more of the mobile platforms 106 includes a processor 124 and a memory 126 configured to store computer program code. The memory 126 and the computer program code are configured to, with the processor 124, cause the processor 124 to perform various operations, functions, and/or the like of the mobile platform 106 and/or the system 100. For example, the processor 124 may function as a central processing entity, managing operations and coordinating data flow between components. The memory 126 is connected to the processor 124 and stores instructions and data necessary for the execution of the various operations, functions, and/or the like of the mobile platform 106 and/or the system 100, such as functions and algorithms for launching, deploying, navigation, maneuvering, communication, and/or the like.

In some examples, one or more operations, functions, results, conclusions, calculations, determinations, generations, detections, and/or the like of the mobile platform 106 and/or the system 100 are provided for display via a graphical user interface (GUI). The GUI includes a GUI 128 of the mobile platform 106 and/or the system 100, and/or a GUI of another system, computing device, electronic device, server, and/or the like. The GUI 128 is interfaced with the processor 124, enabling user interaction and visualization of data processed by the mobile platform 106 and/or the system 100, for example allowing for configuration changes and/or monitoring of the various operations of the mobile platform 106 and/or the system 100.

A controller 130 is optionally operatively connected to the memory 126 and the processor 124 for performing various functions, operations, and/or the like of the mobile platform 106 and/or the system 100. In the illustrated implementation, the controller 130 is configured to perform control, launching, deployment, navigation, flight management, payload release, communication, and other functions, operations, determinations, calculations, and/or the like. For example, the controller 130 may be operatively connected to the communications interface 122 for performing communication operations. The controller 130 may include any hardware, software, and/or the like that enables the controller 130 to function as described and/or illustrated herein, such as, but not limited to, a Raspberry Pi, and/or the like.

Referring now to the GCS 102, the GCS 102 includes a processor 134 and a memory 136 configured to store computer program code. The memory 136 and the computer program code are configured to, with the processor 134, cause the processor 134 to perform various operations, functions, and/or the like of the system 100. For example, the processor 134 may function as a central processing entity, managing operations and coordinating data flow between components. The memory 136 is connected to the processor 134 and stores instructions and data necessary for the execution of the various operations, functions, and/or the like of the system 100, such as functions and algorithms for launching, deploying, communicating, and/or the like.

In some examples, one or more operations, functions, results, conclusions, calculations, determinations, generations, detections, and/or the like of the system 100 is provided for display via a graphical user interface (GUI). The GUI includes a GUI 138 of the system 100, and/or a GUI of another system, computing device, electronic device, server, and/or the like. The GUI 138 is interfaced with the processor 134, enabling user interaction and visualization of data processed by the mobile platforms 106 and/or the system 100, for example allowing for configuration changes and/or monitoring of the various operations of the mobile platforms 106 and/or the system 100.

A controller 140 is operatively connected to the memory 136 and the processor 134 for performing various functions, operations, and/or the like of the mobile platform 106 and/or the system 100. In the illustrated implementation, the controller 140 is configured to perform control, launching, deployment, navigation, flight management, payload release, communication, and other functions, operations, determinations, calculations, and/or the like. For example, the controller 140 may be operatively connected to a communications interface 142 of the GCS 102 for performing communication operations. The controller 140 may include any hardware, software, and/or the like that enables the controller 140 to function as described and/or illustrated herein, such as, but not limited to, a Raspberry Pi, and/or the like.

The communications interface 142 enables the GCS 102 to communicate with the mobile platforms 106, for example for launching and/or deploying the mobile platforms 106 from the stack 104. For example, the communications interface 142 includes a network and/or other communication link for communicating over wireless communication protocols, such as, but not limited to, LANs, WANs, Bluetooth, radio frequency, SDR, line-of-sight communication, relay-based communication, relay-based line-of-sight communication, Wi-Fi, LoRa, LoRaWAN, cellular networks, and/or the like. In one example, the communications interface 142 uses an SDR network that provides line-of-sight communication with the mobile platforms 106. In one example, the communications interface 142 uses relay-based communication with the mobile platforms 106. In some examples, the communication interface 142 provides both direct line-of-sight and relay-based communication paths, for example enabling robustness in controlling launches from local and/or remote locations.

In some examples, to provide radio connections between the mobile platforms 106 and the GCS 102, the communications interface 142 includes one or more of: a mesh radio; a radio operating at approximately 2.4 GHz; a mini mesh radio; a LoRa antenna; an omni-directional antenna (e.g., an HGV-2404U 2.4 GHz omni-direction antenna, etc.); an antenna operating at approximately 2.4 GHz; a dual polarization antenna; a multiple-input multiple-output (MIMO) antenna (e.g., a 2.4 GHz Dual Polarization MIMO panel antenna, etc.); a MIMO panel antenna; and/or the like.

In some examples, the communications interface 142 provides an integrated communication module that enables relatively seamless coordination between deployed mobile platforms 106 and the GCS 102. In some examples, the GCS 102 and the system 100 support real-time data exchange (e.g., including mobile platform telemetry, operation status, etc.), for example enabling all units to operate cohesively and enabling adjustments to be made promptly based on operational developments.

The system 100 optionally includes one or more atmospheric condition sensors 146 (e.g., onboard one or more of the mobile platforms 106, at the GCS 102, remote from but operatively connected to the GCS 102, etc.). For example, each sensor 146 is configured to acquire atmospheric condition data. The sensor(s) 146 may include any number and/or different types of atmospheric condition sensors, such as, but not limited to, cameras, acoustic sensors, microphones, optical sensors, thermal sensors, infrared sensors, microwave sensors, environmental monitors, LiDAR systems, x-ray detectors, electromagnetic field detectors, and/or the like. Atmospheric condition data that is acquired by the sensors 146 may include, but is not limited to, wind speed, wind direction, temperature, humidity, dew point, density altitude, environmental information, environmental variables, wind patterns, terrain features, thermal information, terrain information, other environmental data, and/or the like.

Optionally, the system 100 includes one or more other sensors 148 (e.g., onboard one or more of the mobile platforms 106, at the GCS 102, remote from but operatively connected to the GCS 102, etc.) that are configured to acquire other data, such as, but not limited to, location, position, altitude, elevation, time of day, navigational inputs, visual camera data, infrared camera data, radar, audio information, audio cues, visual information, visual cues, video footage, and/or the like. The sensor(s) 148 may include any number and/or different types of sensors, such as, but not limited to, cameras, acoustic sensors, microphones, optical sensors, thermal sensors, infrared sensors, microwave sensors, environmental monitors, LiDAR systems, x-ray detectors, electromagnetic field detectors, global positioning satellite (GPS) sensors, and/or the like.

The GCS 102 of the system 100 provides a centralized control system enables more efficient organization, identification, and deployment of stacked mobile platforms in a coordinated manner. For example, the system 100 utilizes unique identifiers to automatically ascertain stack order without the involvement of manual sequencing or other relatively complicated electronic systems. Moreover, and for example, the GCS 102 employs programmable methodologies that dictate the sequence and timing of mobile platform launches, for example based upon operational demands and/or the like.

For example, the controller 140 of the GCS 102 is configured to receive identifier data from the mobile platforms 106 within the stack 104. The identifier data received by the GCS 102 from each mobile platform 106 includes identifier data (including the unique identifier 110) of one or more of the mobile platforms 106 that are adjacent in the stack 104 to the mobile platform 106 sending the identifier data to the GCS 102. The identifier data of the adjacent mobile platform(s) 106 in the stack 104 is read by the reader 120 of the sending mobile platform 106. In general, identifier data received by the GCS 102 from one or more mobile platforms 106 includes payload data of the sending mobile platform 106 and/or an adjacent mobile platform 106. For example, in a vertical stack, the upper-most mobile platform 106 sends identifier data of at least one adjacent mobile platform 106 (e.g., the mobile platform 106 beneath the upper-most mobile platform 106) as well as identifier data that corresponds to itself (e.g., including its own unique identifier 110) to the GCS 102. Similarly in the vertical stack example, the bottom-most mobile platform 106 may send no identifier data to the GCS 102, as there are no mobile platforms 106 beneath it.

In the exemplary implementation shown in FIG. 1, each mobile platform 106 (excepting the bottom-most mobile platform 106) sends to the GCS 102 the identifier data of the adjacent mobile platform 106 that is below itself in the stack 104. In other examples, one or more of the mobile platforms 106 sends to the GCS 102 the identifier data of the adjacent mobile platform 106 that is above itself in the stack 104. In some examples, one or more of the mobile platforms 106 sends to the GCS 102 the identifier data of both the adjacent mobile platform 106 that is above itself in the stack 104 and the adjacent mobile platform 106 that is below itself in the stack 104.

In some examples, the GCS 102 requests the identifier data from the mobile platforms 106. Additionally or alternatively, one or more mobile platforms 106 is configured to automatically send identifier data to the GCS 102, for example upon activation, being powered up, turned on, being put into an operational mode, and/or the like. In some examples, the GCS 102 is configured to receive the identifier data from the mobile platforms 106 over a SDR network.

The GCS 102 is configured to automatically determine a stack order of the mobile platforms 106 within the stack 104 based on the received identifier data. For example, the determined stack order indicates the stacked positions of the mobile platforms 106 from the lower-most mobile platform 106 within the stack 104 at the base 112 of the stack 104 to the upper-most mobile platform 106 at the free end 114 of the stack 104, or vice versa. The GCS 102 is configured to use the unique identifiers 110 of the mobile platforms 106 to determine the order in which the mobile platforms 106 are stacked. In some examples, the GCS 102 determines the stack order of the mobile platforms 106 in the stack 104 by analyzing the received identifier data (including the unique identifiers 110) to establish a sequence reflective of the stack order of the mobile platforms 106. For example, the stack order of the mobile platforms 106 can be determined visually utilizing the unique identifiers 110 and the readers 120. In one example, the reader 120 of a mobile platform 106 includes a camera that reads a QR code of the unique identifier 110 of an adjacent mobile platform 106 that is underneath it to determine the order of the stack 104.

In some examples, the GCS processes the input from each mobile platform 106 to determine the stacking order using a sequence of operations facilitated by wireless communication and data interpretation techniques. For example, upon activation, the readers 120 of the mobile platforms 106 read the identifier data (including the unique identifier 110) of the adjacent mobile platforms 106. The captured identifier data is transmitted from the mobile platforms 106 to the GCS 102 via the wireless communication network, for example through an SDR network that supports dynamic interactions. The GCS 102 receives the identifier data and analyzes the unique identifiers 110 received from the stacked formation of mobile platforms 106. For example, the sequence of unique identifiers 110 received from the stacked formation establishes a sequential data chain relative to the base 112 of the stack 104. Based on the analyzed sequential data chain, the GCS 102 infers the stacking order of the mobile platforms 106. To facilitate more accurate interpretation in some examples, the GCS 102 applies a sorting algorithm that organizes the received identifier data into a definitive sequence that reflects the physical arrangement of mobile platforms 106 within the stack 104.

Optionally, the GCS 102 is configured to determine the stack order of the mobile platforms 106 within the stack 104 based on the received identifier data and based on one or more operational parameters (e.g., an operational requirement, an operational objective, an operational demand, a capability of one or more of the mobile platforms 106, an operational mode of launch, an operational formation of the mobile platforms 106, a destination parameter, payload data, environmental data, etc.). The determined stack order of the mobile platforms 106 in the stack 104 may be updated based on newly received identifier data, changes in a formation of the mobile platforms, changes to one or more operational parameters, and/or the like.

The GCS 102 is configured to determine a launch sequence of the mobile platforms 106 based on the determined stack order of the mobile platforms 106. The GCS 102 is configured to select a launch strategy based on the determined launch sequence. In some examples, the GCS 102 is configured to select the launch strategy from a plurality of pre-programmed launch strategies and/or launch methodologies stored in a memory (e.g., the memory 136, etc.).

In some examples, the GCS 102 incorporates a dynamic sequencing mechanism that enables a dynamic launch sequencing configuration, for example enabling programmable launch intervals, launch sequences, and/or the like. The dynamic sequencing mechanism enhances the capability to deploy mobile platforms 106 based on operation-specific timing, order requirements, and/or the like, for example improving synchronization with tactical and/or operational plans.

The GCS 102 is optionally configured to determine, adjust, and/or reconfigure the launch sequence based on one or more operational parameters, such as, but not limited to, an operational requirement, an operational objective, an operational demand, a capability of one or more of the mobile platforms 106, an operational mode of launch, an operational formation of the mobile platforms 106, a destination parameter, payload data, environmental data, and/or the like. For example, the GCS 102 may be configured to correlate the determined launch sequence with one or more operational parameters to configure launch strategies accordingly. In some examples, the GCS 102 integrates the corelated information to dynamically adapt the launch sequence based on operational requirements. In some examples, the timing between launches of the mobile platforms 106 is configured to meet specific operational parameters, operational objectives, and/or the like.

In some examples, the launch strategy selected by the GCS 102 includes one or more sequential launches of the mobile platforms 106, one or more individual launches (e.g., one-at-a-time, etc.) of a mobile platform 106, and/or the like. For example, the launch strategy selected by the GCS 102 may include launching the mobile platforms 106 individually spaced apart by at least one defined time interval. In some examples, the selected launch strategy includes a blitzkrieg mode wherein all the mobile platforms 106 are launched from the stack 104 as quickly as possible.

The GCS 102 is configured to implement a launch methodology based on the determined launch sequence of the mobile platforms. For example, the GCS 102 is configured to instruct the mobile platforms 106 to launch according to the selected launch strategy by dispatching the mobile platforms 106 from the stack in accordance with the determined stack order.

For example, in some implementations, the GCS 102 directs the launch of a mobile platform 106 by employing a software-based command system, for example transmitted through wireless communication between the GCS 102 and the mobile platform 106. The GCS 102 identifies the position of the mobile platform 106 within the order of the stack 104 using the unique identifier 110 received from the reader 120 of an adjacent mobile platform 106. Based on the stack order (and optionally one or more operational parameters), the GCS 102 determines the sequence and timing of the launch of the mobile platform 106. The GCS 102 sends a launch command to the mobile platform 106, for example via an SDR network. The launch command includes specific parameters for takeoff of the mobile platform 106, such as, but not limited to, propulsion activation, ascent velocity, initial flight trajectory, and/or the like. Upon receiving the command, the mobile platform 106 activates its propulsion system and initiates the ascent phase. In some examples, the GCS 102 continuously monitors the status and progression of the mobile platform 106, for example adjusting commands as necessary to ensure adherence to the planned launch strategy, to address any detected anomalies, and/or the like. For example, in some implementations, the GCS 102 establishes continuous communication with the mobile platforms 106 of the stack 104, for example ensuring real-time updates on launch status and adjustment of launch strategies as desired.

The GCS 102 is configured to implement various timing strategies. One example of a launch strategy and/or methodology that may be implemented by the system 100 includes a relatively rapid sequential launch mode referred to herein as a blitzkrieg mode. In the blitzkrieg mode, the GCS 102 initiates a relatively fast succession of launches with minimal intervals between each launch. In other words, in the blitzkrieg mode, the GCS 102 activates a swift release mechanism, dispatching each mobile platform 106 in the stack 104 in relatively rapid succession (e.g., as quickly as possible, etc.). The blitzkrieg strategy may be particularly applicable to scenarios requiring immediate deployment of multiple mobile platforms, relatively rapid response actions, immediate extensive coverage, and/or the like (e.g., optimizing time efficiency and operational impact, etc.).

Another example of a launch strategy and/or methodology that may be implemented by the system (e.g., the GCS 102, etc.) is staggered launch timing, for example offering both automatic and manual operational modes. In automatic mode, the GCS 102 adheres to one or more pre-defined time intervals between launches (e.g., a pred-defined schedule, etc.), for example accounting for (e.g., calculating based on, etc.) one or more operational parameters such as, but not limited to, distance to target, payload characteristics, destination parameters, payload deployment timing, synchronization with ground activities, operational requirements, and/or the like. The automatic time interval(s) enables appropriate spacing to achieve higher deployment efficiency and higher payload delivery synchronization.

The manual mode of the staggered launch timing offers the flexibility for an operator to adjust the timing between launches dynamically (e.g., operator-defined timing adjustments, etc.). For example, manual mode provides discretion over deployment timings, for example enabling better adaptability to evolving tactical environments and/or changing operational demands. The manual mode provides the operator with discretion to initiate launches individually, for example granting enhanced control over deployment by enabling more precise timing adjustments in response to dynamic field conditions.

In some examples, the GCS 102 integrates reconfigurable launch sequences aligned with one or more operational parameters, permitting alterations in launch order. For example, the timing between launches of the mobile platforms 106 may be reconfigured to satisfy specific parameters, objectives, and/or the like. The integration of reconfigurable launch sequences enables adaptability, for example providing prioritized payload delivery, providing strategic positioning, augmenting versatility, and/or the like.

As discussed above, and regardless of the selected mode, launch strategy, or launch methodology, the selected timing between launches of two or more of the mobile platforms 106 may be influenced by (e.g., based on, etc.) several factors, such as, but not limited to, operational parameters, payload characteristics, destination parameters, selected mode of launch, ground activity synchronization, environmental conditions, and/or the like. For example, in some examples, the timing between launches of two or more mobile platforms 106 is influenced (e.g., dictated, suggested, etc.) by one or more operational parameters such as, but not limited to, urgency of deployment, geographical area coverage, operational (e.g., tactical, etc.) objectives, and/or the like. In another example, the type and/or characteristics of a payload carried by one or more of the mobile platforms 106 may influence the timing between launches of two or more mobile platforms 106, for example enabling better synchronization with operational tasks, payload deployment sequences, and/or the like. In an example of a destination parameter influencing the timing, the intended target and/or location may influence timing considerations, for example to enable mobile platforms 106 to arrive at and/or function within an operationally coordinated timeframe. In some examples, the operational mode selected (e.g., automatic, manual, blitzkrieg, staggered, etc.) influences the selected timing between launches of two or more mobile platforms 106. In a ground activity synchronization example, concurrent ground activities (e.g., support operations, staged interventions, etc.) may dictate synchronized launches of the mobile platforms 106 for cohesive execution of an operation. Examples of environmental conditions that influence the launch timing include prevailing environmental factors and/or atmospheric conditions influencing the timing between launches, for example to enable appropriate spacing and flight path accuracy thereby reducing potential impacts on coordination between the mobile platforms 106.

In some examples, the system 100 (e.g., the GCS 102, etc.) incorporates error-handling and/or mitigation strategies, for example to enable the GCS 102 to actively adapt to unforeseen conditions, maintain operation integrity, enhance the robustness of the system 100, and/or the like. For example, an identifier misreading error occurs when a reader 120 misreads or fails to detect the unique identifier of the adjacent mobile platform 106. In some examples, upon an identifier misreading error, the GCS 102 initiates a verification protocol, wherein the GCS 102 commands the affected mobile platform 106 to reposition slightly and attempt re-reading. If repeated attempts fail, the GCS 102 may deploy additional optical recognition algorithms and/or direct nearby mobile platforms 106 to perform collective reading to confirm the identifier data.

Another error example is a communication drop error, which is encountered when there is a loss of wireless communication between the GCS 102 and any mobile platform 106 in the stack 104. In some examples, the GCS 102 utilizes redundant communication paths (e.g., through an SDR network, etc.) to re-establish contact. If unsuccessful, the system 100 implements a relay mode, engaging intermediate mobile platforms 106 to extend the communication range and restore connectivity with the GCS 102.

A launch sequence anomaly error is triggered if the launch sequence deviates, for example due to unplanned interruptions and/or miscalculations in stacking order data. Upon encountering a launch sequence anomaly, the GCS 102 may halt ongoing launches (e.g., immediately) and recalibrate the sequence, for example by re-analyzing stored stack data and operational parameters. In some examples, a contingency algorithm is deployed to order or reorder the launch sequence, for example prioritizing mobile platforms 106 with time-sensitive payloads, certain types of payloads, higher operational significance, and/or the like. For example, mobile platforms 106 with high-resolution cameras may be deployed first, following by mobile platforms 106 with medicine payloads.

An environmental interference error arises when adverse weather conditions and/or unexpected physical obstructions affect the optical and/or radio signals utilized by the system 100. In some examples, the GCS 102 adjusts operational parameters to incorporate enhanced filtration and/or noise-cancellation algorithms, improving signal clarity. For example, the mobile platforms 106 are instructed to ascend to more favorable altitudes and/or positions to improve signal reception and/or identifier visibility.

A stack physical instability error occurs when unexpected imbalances and/or mechanical shifts occur within the physical stacking of the mobile platforms 106. In some examples, upon encountering a stack physical instability error, the GCS 102 deploys an emergency stabilization protocol, engaging mobile platforms 106 with stabilization mechanisms and/or recommending automated deployment to alleviate pressure on the stack 104. In some examples, the GCS 102 analyzes sensor feedback (e.g., from the sensors 146 and/or 148, etc.) to diagnose structural vulnerabilities and advise manual intervention if necessary.

A payload misalignment error occurs when payload data does not match actual payloads (e.g., due to identifier data inaccuracies, etc.). To mitigate a payload misalignment error, the GCS 102 may initiate a cross-reference check against stored inventory data, followed by command sequences directing adjacent mobile platforms 106 to perform inter-mobile platform confirmation. When discrepancies persist, the GCS 102 may adjust deployment strategies to accommodate known payload corrections.

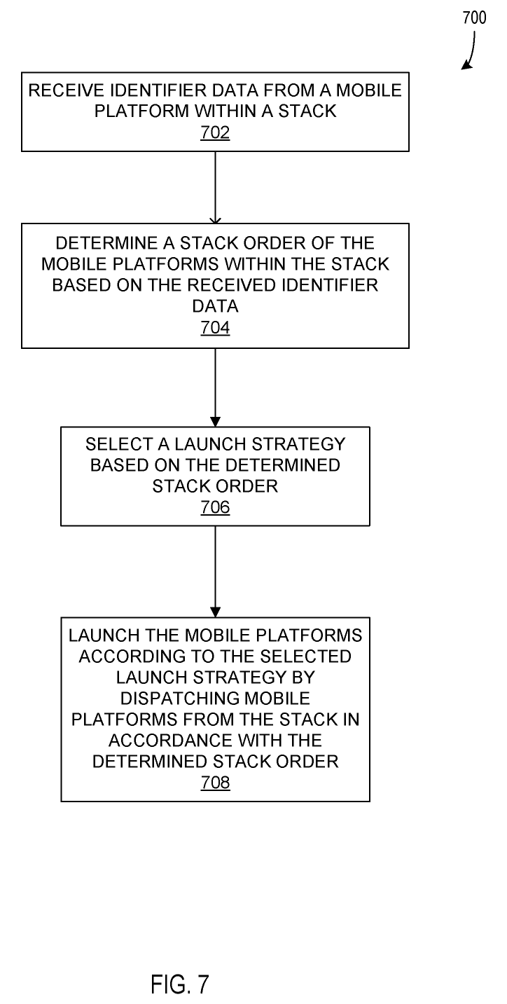

FIG. 7 is a flowchart illustrating an example of a method 700 of operations, functions, and/or the like of the system 100 (FIG. 1). At 702, the method 700 includes receiving identifier data from a mobile platform within a stack of mobile platforms, wherein the identifier data comprises a unique identifier of an adjacent mobile platform within the stack. At 704, the method 700 includes determining a stack order of the mobile platforms within the stack based on the received identifier data. The method 700 includes selecting, at 706, a launch strategy based on the determined stack order. At 708, the method 700 includes launching the mobile platforms according to the selected launch strategy by dispatching mobile platforms from the stack in accordance with the determined stack order.

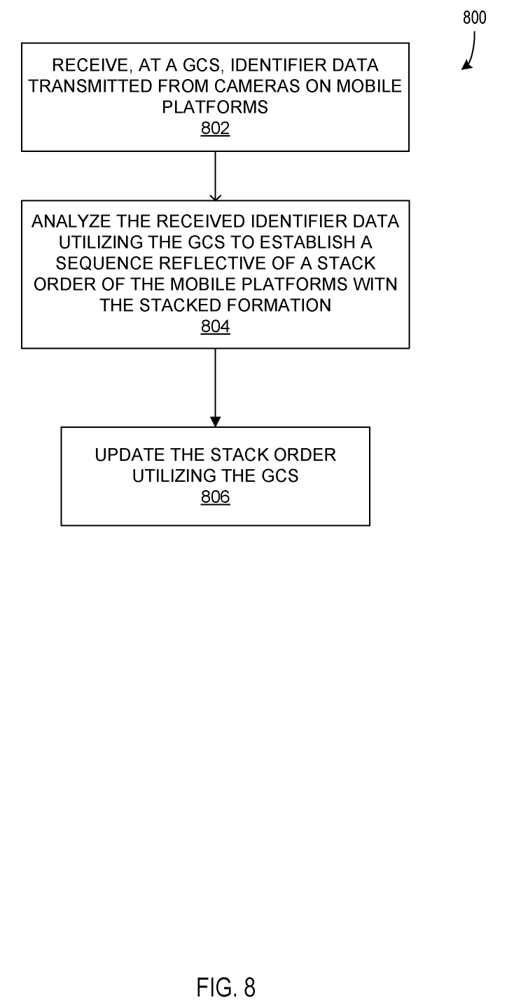

FIG. 8 is a flowchart illustrating an example of a method 800 of operations, functions, and/or the like of the system 100 (FIG. 1). At 802, the method 800 includesreceiving, at a GCS in wireless communication with a plurality of stackable mobile platforms through an SDR network, identifier data transmitted from cameras on the mobile platforms, with the identifier data corresponding to unique identifiers located on surfaces of adjacent mobile platforms within a stacked formation of the mobile platforms. The method 800 includes analyzing, at 804, the received identifier data utilizing the GCS to establish a sequence reflective of a stack order of the mobile platforms within the stacked formation. At 806, the method 800 includes updating the stack order utilizing the GCS based on at least one of newly received identifier data, a change in the stacked formation of the mobile platforms, an operational parameter, a payload delivery requirement, or a tactical deployment strategy.

### Other Implementations

Referring to FIG. 1, another method used by the GCS 102 to determine the stacking order of the mobile platforms 106 includes the use of alternative sensor systems integrated within each mobile platform 106. For example, each mobile platform 106 could be equipped with relatively short-range communication modules, such as Bluetooth and/or infrared sensors, which would detect proximity to adjacent mobile platforms 106. In some examples, protocol-based pings are established to ascertain the spatial relationship between mobile platforms 106 stacked in vertical formations.

Another approach involves the application of weight-based sensors integrated into a launching platform (e.g., a structure that holds and/or supports the mobile platforms 106 within the stack 104, a structure on which the stack 104 of mobile platforms 106 rests, etc.). In some examples, each mobile platform 106 is calibrated with a weight measurement, for example enabling a stacking order determination based on the weight distribution detected by pressure-sensitive elements incorporated into the launching platform.

Magnetic sensors also serve, in some examples, as a method for stack order identification. For example, the magnetic sensors may be employed to detect signature magnetic markers embedded within the structural framework of each mobile platform 106. By assessing the sensor data, the system 100 determines both the presence and order of mobile platforms 106 based on unique magnetic profiles.

In some examples, laser rangefinders are used for stack order determination, for example rotating and/or sequentially deployed from the launching platform and/or the mobile platforms 106 for measuring distances between mobile platforms 106. Laser rangefinder measurements facilitate an understanding of stacking order by providing data corresponding to fixed distance intervals between mobile platforms 106.

Radio Frequency Identification (RFID) technology may be used to determine the stacking order of the mobile platforms 106. For example, RFID may feature active and/or passive tags that broadcast and/or reflect coded signals. The GCS 102 and/or the mobile platforms 106 could then receive the coded signals to confirm their relative positions in the stack 104.

In some examples, visual recognition algorithms are deployed via synthesized stereoscopic cameras to provide an image-based method of determining the stacking order. For example, the visual recognition algorithms utilize pattern and/or texture recognition to identify distinct markings and/or embossed numbers on the mobile platforms 106, for example enabling an inference of stacking order based on spatial assessment gathered through visual feedback.

As discussed above, the stack 104 of the mobile platforms 106 are not limited to being orientated generally vertically with respect to the ground and/or other surface on which the stack 104 rests. In some examples, the stack 104 is orientated generally horizontally with respect to the ground and/or other surface on which the stack 104 rests (e.g., a side-by-side stack). To determine the order of mobile platforms 106 that are stacked in this way, other methods may be additionally or alternatively utilized, similar in principle to those applied in vertical stacking but adapted for horizontal stacking.

For example, the identifier data (including the unique identifier 110) may be positioned on lateral surfaces of the mobile platforms 106 that are visible to a side-facing reader 120 on an adjacent mobile platform 106. Upon activation, the side-facing readers 120 capture the identifier data of adjacent mobile platforms 106 within a side-by-side stack. The identifier data read by the side-facing readers 120 is communicated back to the GCS 102, which interprets the sequence of unique identifiers 110 to establish the order of the side-by-side stack.

In some examples, proximity sensors (e.g., short-range communication modules such as, but not limited to, Bluetooth and/or infrared sensors, etc.) are integrated laterally on mobile platforms 106 to detect proximity to adjacent (e.g., neighboring, etc.) mobile platforms 106 in the horizontal stack. In some examples, the proximity sensors perform targeted pings following orientation protocols to ascertain relative order, with data transmitted to the GCS 102 for sequence determination.

In some examples, weight-based identification is utilized to determine the order of mobile platforms 106 within a horizontal stack. For example, a weight-sensitive launch platform configured with pressure sensors could discern the initial positioning of side-by-side (e.g., horizontally) stacked mobile platforms 106, with the system 100 (e.g., the GCS 102, etc.) calculating the order based on weight distribution data collected as mobile platforms 106 are moved onto the launch platform.

Magnetic and/or RFID markers may be utilized to determine the order of mobile platforms 106 within a side-by-side stack. For example, implementing magnetic signatures and/or RFID tags along lateral aspects of the mobile platforms 106 enables magnetic and/or RFID sensors (e.g., the readers 120, etc.) on the mobile platforms 106 and/or the launch platform to detect specific markers, thereby determining stack order based on pre-assigned magnetic profiles and/or RFID codes.

Laser and/or visual recognition methods may be utilized to determine the order of mobile platforms 106 within a side-by-side stack. For example, horizontally mounted and/or mobile laser rangefinders can measure fixed intervals and/or distances between mobile platforms 106, illuminating positional data related to orientation. In addition or alternatively, visual recognition algorithms could deploy stereoscopic and/or monocular cameras with pattern and/or texture recognition capabilities to identify distinct markings, establishing horizontal stack order based on this visual feedback.

### Exemplary Operating Environment

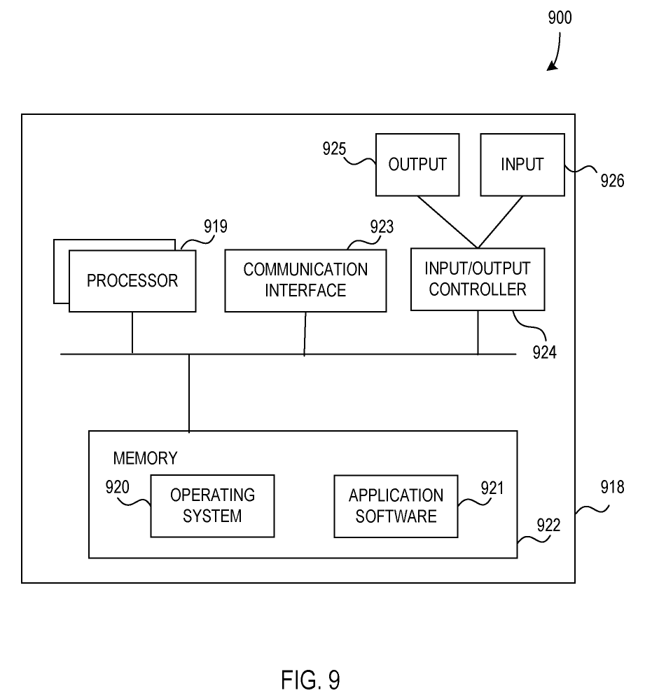

The present disclosure is operable with a computing apparatus according to an implementation as a functional block diagram 900 in FIG. 9. In an example, components of a computing apparatus 918 are implemented as a part of circuitry of an electronic device according to one or more implementation described in this specification. The computing apparatus 918 comprises one or more processors 919 which may be microprocessors, controllers, or any other suitable type of processors for processing computer executable instructions to control the operation of the electronic device. Alternatively, or in addition, the processor 919 is any technology capable of executing logic or instructions, such as a hard-coded machine. In some examples, platform software comprising an operating system 920 and/or any other suitable platform software is provided on the apparatus 918 to enable application software 921 to be executed on the device.

In some examples, the operations, actions, and/or the like of the systems disclosed herein (e.g., determining a stack order and/or a launch sequence, launching mobile platforms, etc.) is accomplished by software, hardware, firmware, and/or the like operating on a single device (e.g., a software module, a processor, a core, a firmware module, and/or the like) or distributed across multiple devices (e.g., one or more software modules, one or more processors, one or more cores, one or more firmware modules, and/or the like). For example, the systems disclosed herein may include a computer storage medium storing instructions that, when executed across two or more processors (and/or across two or more cores of one or more processors), cause the processors (and/or the cores) of the system to collectively perform the operations, actions, and/or the like of the system. For example, one processor of the system could perform one or more of the operations, actions, and/or the like of the system, while another processor could perform one or more other operations, actions, and/or the like of the system.

As used in this application, the term “circuitry” may refer to one or more or all of the following: (a) hardware-only circuit implementations (such as implementations in analog, digital, and/or quantum circuitry); (b) combinations of hardware circuit(s) and software, such as (as applicable): (i) combination of analog, digital, and/or quantum hardware circuit(s) with software/firmware, and (ii) any or all portions of hardware processor(s) (including digital and/or quantum processor(s)) with software, and memory(ies) that work together to cause an apparatus, such as a mobile device, computing device, and/or server, to perform various functions; and (c) any or all portions of hardware circuit(s), such as a microprocessor(s), processor(s), and/or quantum processor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit and/or processor (or multiple processors) and/or portion of a hardware circuit and/or processor and its (and/or their) accompanying software and/or firmware. The term circuitry also covers, for example, and if applicable to the particular claim element, a baseband integrated circuit and/or processor integrated circuit for a mobile device and/or a similar integrated circuit in server, a cellular network device, and/or other computing and/or network device.

In some examples, computer executable instructions are provided using any computer-readable media that is accessible by the computing apparatus 918. Computer-readable media include, for example, computer storage media and communications media. Computer storage media, such as a memory 922, include volatile and non-volatile, removable, and non-removable media implemented in any method or technology for storage of information such as computer readable instructions, data structures, program modules, and/or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media does not include communication media. Therefore, a computer storage medium is not a propagating signal. Propagated signals are not examples of computer storage media. Although the computer storage medium (the memory 922) is shown within the computing apparatus 918, it will be appreciated by a person skilled in the art, that, in some examples, the storage is distributed or located remotely and accessed via a network or other communication link (e.g., using a communication interface 923).

Further, in some examples, the computing apparatus 918 comprises an input/output controller 924 configured to output information to one or more output devices 925, for example a display (e.g., displaying a GUI) or a speaker, which are separate from or integral to the electronic device. Additionally, or alternatively, the input/output controller 924 is configured to receive and process an input from one or more input devices 926, for example, a keyboard, a microphone, or a touchpad. In one example, the output device 925 also acts as the input device. An example of such a device is a touch sensitive display. The input/output controller 924 may also output data to devices other than the output device, e.g., a locally connected printing device. In some examples, a user provides input to the input device(s) 926 and/or receives output from the output device(s) 925.

The functionality described herein can be performed, at least in part, by one or more hardware logic components. According to an implementation, the computing apparatus 918 is configured by the program code when executed by the processor 919 to execute the implementations of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, or the like) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

### Examples

Aspects of the disclosure include a system that includes mobile platforms arranged in a stack. The mobile platforms include unique identifiers. The system includes a ground control station (GCS) configured to wirelessly communicate with the mobile platforms. The GCS is configured to receive identifier data from the mobile platforms within the stack, wherein the identifier data received from the mobile platforms comprises the unique identifier of an adjacent mobile platform within the stack. The GCS is configured to determine a stack order of the mobile platforms within the stack based on the received identifier data, determine a launch sequence of the mobile platforms based on the determined stack order, and implement a launch methodology based on the determined launch sequence.

In some examples, the mobile platforms include cameras configured to read the unique identifier of adjacent mobile platforms within the stack.

In some examples, the mobile platforms includes cameras configured to read the unique identifier of adjacent mobile platforms within the stack, wherein the cameras face downward relative to the stack such that the camera of a corresponding mobile platform is configured to read the unique identifier of the adjacent mobile platform that is below the corresponding mobile platform within the stack.

In some examples, the unique identifier includes at least one of a near-field communication (NFC) tag or a quick response (QR) code.

Optionally, the GCS is configured to communicate with the mobile platforms using at least one of: a software defined radio (SDR) network providing line-of-sight communication; or a relay-based communication.

In some examples, the launch methodology includes at least one of sequential or individual mobile platform launches.

In some examples, the GCS is configured to implement the launch methodology based on the determined launch sequence by selecting the launch methodology from a plurality of pre-programmed launch methodologies stored in a memory.

Optionally, the GCS is configured to at least one of: determine the stack order of the mobile platforms within the stack based on the received identifier data and based on an operational parameter; or at least one of adjust or reconfigure the determined launch sequence based on the operational parameter.

In some examples, the GCS is further configured to at least one of adjust or reconfigure the determined launch sequence based on an operational parameter including at least one of a payload delivery parameter, a deployment parameter, or a deployment strategy.

In some examples, receiving the identifier data includes receiving payload data of at least one of the mobile platforms.

Aspects of the disclosure include a method that includes receiving identifier data from a mobile platform within a stack of mobile platforms, wherein the identifier data comprises a unique identifier of an adjacent mobile platform within the stack. The method includes determining a stack order of the mobile platforms within the stack based on the received identifier data, selecting a launch strategy based on the determined stack order, and launching the mobile platforms according to the selected launch strategy by dispatching mobile platforms from the stack in accordance with the determined stack order.

In some examples, the selected launch strategy includes at least one of sequential or individual mobile platform launches.

Optionally, receiving the identifier data includes at least one of: receiving the identifier data at a ground control station (GCS) that is configured to wirelessly communicate with the mobile platforms within the stack; receiving the identifier data from a plurality of the mobile platforms within the stack, wherein the identifier data received from the mobile platforms comprises the unique identifier of at least one adjacent mobile platform within the stack; receiving the identifier data from a camera of the mobile platform; receiving the identifier data from the camera of the mobile platform, wherein the camera faces downward relative to the stack; receiving at least one of a near-field communication (NFC) tag or a quick response (QR) code; or receiving payload data of the adjacent mobile platform.

In some examples, determining the stack order based on the received identifier data includes determining the stack order based on identifier data received from the mobile platforms within the stack.

Optionally, selecting the launch strategy includes at least one of: selecting the launch strategy from a plurality of pre-programmed launch strategies stored in a memory; or selecting a blitzkrieg mode.

Optionally, the method further includes reconfiguring a launch sequence of the mobile platforms in response to a received operational parameter comprising at least one of a payload delivery parameter or a deployment parameter.

In some examples, the method further includes equipping the mobile platforms with the unique identifier such that the unique identifier can be read by a camera on another mobile platform.

In some examples, launching the mobile platforms includes launching the mobile platforms individually spaced apart by at least one time interval.

Optionally, determining the stack order of the mobile platforms within the stack includes at least one of: analyzing the received identifier data to establish a sequence reflective of the stack order of the mobile platforms; correlating the established sequence with operational parameters; or updating the determined stack order based on at least one of newly received identifier data or changes in a mobile platform formation.

Aspects of the disclosure include a method that includes receiving, at a Ground Control Station (GCS) in wireless communication with a plurality of stackable mobile platforms through a Software Defined Radio (SDR) network, identifier data transmitted from cameras on the mobile platforms, with the identifier data corresponding to unique identifiers located on surfaces of adjacent mobile platforms within a stacked formation of the mobile platforms. The method includes analyzing the received identifier data utilizing the GCS to establish a sequence reflective of a stack order of the mobile platforms within the stacked formation, and updating the stack order utilizing the GCS based on at least one of newly received identifier data, a change in the stacked formation of the mobile platforms, an operational parameter, a payload delivery requirement, or a tactical deployment strategy.

Aspects of the disclosure include a method for launching mobile platforms from a stackable formation on a launching platform. The method includes activating a Ground Control Station (GCS) in wireless communication with a plurality of stackable mobile platforms via a Software Defined Radio (SDR) network. The method includes receiving, at the GCS, identifier data from downward-facing cameras on each mobile platform, the data corresponding to unique identifiers on surfaces of adjacent mobile platforms in the stack. The method includes determining a stack order of the mobile platforms based on the received identifier data, selecting a launch strategy from a plurality of pre-programmed launch strategies stored in the GCS, wherein the launch strategy includes at least one of sequential or individual mobile platform launches. The method includes executing a launch according to the selected strategy by controlling dispatch of mobile platforms from the stack in accordance with the determined stack order, and reconfiguring the launch sequence dynamically in response to received operational parameters, including payload delivery requirements and tactical deployment needs.

Aspects of the disclosure include a system for deploying multiple stackable mobile platforms from a launching platform. The system includes a plurality of mobile platforms, each mobile platform including an identifier disposed on a surface configured to be read by a downward-facing camera on an adjacent mobile platform. The system includes a Ground Control Station (GCS) configured to wirelessly communicate with the plurality of mobile platforms via a Software Defined Radio (SDR) network. The GCS is programmed to: process identifier data received from the downward-facing cameras of the mobile platforms to ascertain a stack order of the mobile platforms, manage a launch sequence of the mobile platforms based on the stack order and mission parameters, implement a launch methodology, with a selectable strategy from a plurality of launch strategies, that includes sequential and individual launches, and reconfigure the launch sequence in response to operational parameters including payload delivery requirements and tactical deployment strategies.

Aspects of the disclosure include a method for determining the stacking order of mobile platforms from a stackable formation on a launching platform via a Ground Control Station (GCS). The method includes activating the GCS in wireless communication with a plurality of stackable mobile platforms through a Software Defined Radio (SDR) network, and receiving, at the GCS, identifier data transmitted from downward-facing cameras on each mobile platform, with the identifier data corresponding to unique identifiers located on surfaces of adjacent mobile platforms within the stackable formation. The method includes analyzing the received identifier data by the GCS to establish a sequence reflective of the stack order of the mobile platforms, correlating the established sequence with pre-determined mission parameters stored in the GCS to configure subsequent operational strategies, and periodically updating the determined stack order by the GCS based on newly received identifier data or changes in mobile platform formation, thereby facilitating adaptive management of operational requirements.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one implementation or may relate to several implementations. The implementations are not limited to those that solve any or all of the stated problems or those that have any or all of the stated benefits and advantages. It will further be understood that reference to ‘an’ item refers to one or more of those items.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements. Any of the functions, operations, and/or the like of the systems, methods, and the like disclosed herein are, in some examples, performed automatically by one or more processors, modules, AI engines, models, and/or the like.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation (e.g., different steps) is within the scope of aspects of the disclosure.

The term “comprising” is used in this specification to mean including the feature(s) or act(s) followed thereafter, without excluding the presence of one or more additional features or acts. The terms "comprising," "including," and "having" are intended to be inclusive and mean that there can be additional elements other than the listed elements. In other words, the use of "including," "comprising," "having," "containing," "involving," and variations thereof, is meant to encompass the items listed thereafter and additional items. Accordingly, and for example, unless explicitly stated to the contrary, implementations "comprising" or "having" an element or a plurality of elements having a particular property can include additional elements not having that property. Further, references to “one implementation” or “an implementation” are not intended to be interpreted as excluding the existence of additional implementations that also incorporate the recited features. The term “exemplary” is intended to mean “an example of”.

When introducing elements of aspects of the application or the examples thereof, the articles "a," "an," "the," and "said" are intended to mean that there are one or more of the elements. In other words, the indefinite articles "a", “an”, “the”, and “said” as used in the specification and in the claims, unless clearly indicated to the contrary, should be understood to mean "at least one." Accordingly, and for example, as used herein, an element or step recited in the singular and preceded by the word "a" or "an" should be understood as not necessarily excluding the plural of the elements or steps.

The phrase “one or more of the following: A, B, and C” means “at least one of A and/or at least one of B and/or at least one of C." The phrase "and/or", as used in the specification and in the claims, should be understood to mean "either or both" of the elements so conjoined, i.e., elements that are conjunctively present in some cases and disjunctively present in other cases. Multiple elements listed with "and/or" should be construed in the same fashion, i.e., "one or more" of the elements so conjoined. Other elements may optionally be present other than the elements specifically identified by the "and/or" clause, whether related or unrelated to those elements specifically identified. Thus, as a non-limiting example, a reference to "A and/or B", when used in conjunction with open-ended language such as "comprising" can refer, in one implementation, to A only (optionally including elements other than B); in another implementation, to B only (optionally including elements other than A); in yet another implementation, to both A and B (optionally including other elements); etc.

As used in the specification and in the claims, "or" should be understood to have the same meaning as "and/or" as defined above. For example, when separating items in a list, "or" or "and/or" shall be interpreted as being inclusive, i.e., the inclusion of at least one, but also including more than one, of a number or list of elements, and, optionally, additional unlisted items. Only terms clearly indicated to the contrary, such as "only one of or "exactly one of," or, when used in the claims, "consisting of," will refer to the inclusion of exactly one element of a number or list of elements. In general, the term "or" as used shall only be interpreted as indicating exclusive alternatives (i.e., "one or the other but not both") when preceded by terms of exclusivity, such as "either," "one of' "only one of' or "exactly one of." "Consisting essentially of," when used in the claims, shall have its ordinary meaning as used in the field of patent law.

As used in the specification and in the claims, the phrase "at least one," in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase "at least one" refers, whether related or unrelated to those elements specifically identified. Thus, as a non-limiting example, "at least one of A and B" (or, equivalently, "at least one of A or B," or, equivalently "at least one of A and/or B") can refer, in one implementation, to at least one, optionally including more than one, A, with no B present (and optionally including elements other than B); in another implementation, to at least one, optionally including more than one, B, with no A present (and optionally including elements other than A); in yet another implementation, to at least one, optionally including more than one, A, and at least one, optionally including more than one, B (and optionally including other elements); etc.

Use of ordinal terms such as "first," "second," "third," etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

It is to be understood that the above description is intended to be illustrative, and not restrictive. For example, the above-described implementations (and/or aspects thereof) can be used in combination with each other. In addition, many modifications can be made to adapt a particular situation or material to the teachings of the various implementations of the application without departing from their scope. While the dimensions and types of materials described herein are intended to define the parameters of the various implementations of the application, the implementations are by no means limiting and are example implementations. Many other implementations will be apparent to those of ordinary skill in the art upon reviewing the above description. The scope of the various implementations of the application should, therefore, be determined with reference to the appended claims, along with the full scope of equivalents to which such claims are entitled. In the appended claims, the terms "including" and "in which" are used as the plain-English equivalents of the respective terms "comprising" and "wherein." Moreover, the terms "first," "second," and "third," etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various implementations of the application, including the best mode, and also to enable any person of ordinary skill in the art to practice the various implementations of the application, including making and using any devices or systems and performing any incorporated methods. The patentable scope of the various implementations of the application is defined by the claims, and can include other examples that occur to those persons of ordinary skill in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A system comprising:
mobile platforms arranged in a stack, wherein the mobile platforms include unique identifiers; and
a ground control station (GCS) configured to wirelessly communicate with the mobile platforms, wherein the GCS is configured to:
receive identifier data from the mobile platforms within the stack, wherein the identifier data received from the mobile platforms comprises the unique identifier of an adjacent mobile platform within the stack;
determine a stack order of the mobile platforms within the stack based on the received identifier data;
determine a launch sequence of the mobile platforms based on the determined stack order; and
implement a launch methodology based on the determined launch sequence.

2. The system of claim 1, wherein the mobile platforms comprise cameras configured to read the unique identifier of adjacent mobile platforms within the stack.

3. The system of claim 1, wherein the mobile platforms comprise cameras configured to read the unique identifier of adjacent mobile platforms within the stack, wherein the cameras face downward relative to the stack such that the camera of a corresponding mobile platform is configured to read the unique identifier of the adjacent mobile platform that is below the corresponding mobile platform within the stack.

4. The system of claim 1, wherein the unique identifier comprises at least one of a near-field communication (NFC) tag or a quick response (QR) code.

5. The system of claim 1, wherein the GCS is configured to communicate with the mobile platforms using at least one of:
a software defined radio (SDR) network providing line-of-sight communication; or
a relay-based communication.

6. The system of claim 1, wherein the launch methodology comprises at least one of sequential or individual mobile platform launches.

7. The system of claim 1, wherein the GCS is configured to implement the launch methodology based on the determined launch sequence by selecting the launch methodology from a plurality of pre-programmed launch methodologies stored in a memory.

8. The system of claim 1, wherein the GCS is configured to at least one of:
determine the stack order of the mobile platforms within the stack based on the received identifier data and based on an operational parameter; or
at least one of adjust or reconfigure the determined launch sequence based on the operational parameter.

9. The system of claim 1, wherein the GCS is further configured to at least one of adjust or reconfigure the determined launch sequence based on an operational parameter comprising at least one of a payload delivery parameter, a deployment parameter, or a deployment strategy.

10. The system of claim 1, wherein receiving the identifier data comprises receiving payload data of at least one of the mobile platforms.

11. A method comprising:
receiving identifier data from a mobile platform within a stack of mobile platforms, wherein the identifier data comprises a unique identifier of an adjacent mobile platform within the stack;
determining a stack order of the mobile platforms within the stack based on the received identifier data;
selecting a launch strategy based on the determined stack order; and
launching the mobile platforms according to the selected launch strategy by dispatching mobile platforms from the stack in accordance with the determined stack order.

12. The method of claim 11, wherein the selected launch strategy comprises at least one of sequential or individual mobile platform launches.

13. The method of claim 11, wherein receiving the identifier data comprises at least one of:
receiving the identifier data at a ground control station (GCS) that is configured to wirelessly communicate with the mobile platforms within the stack;
receiving the identifier data from a plurality of the mobile platforms within the stack, wherein the identifier data received from the mobile platforms comprises the unique identifier of at least one adjacent mobile platform within the stack;
receiving the identifier data from a camera of the mobile platform;
receiving the identifier data from the camera of the mobile platform, wherein the camera faces downward relative to the stack;
receiving at least one of a near-field communication (NFC) tag or a quick response (QR) code; or
receiving payload data of the adjacent mobile platform.

14. The method of claim 11, wherein determining the stack order based on the received identifier data comprises determining the stack order based on identifier data received from the mobile platforms within the stack.

15. The method of claim 11, wherein selecting the launch strategy comprises at least one of:
selecting the launch strategy from a plurality of pre-programmed launch strategies stored in a memory; or
selecting a blitzkrieg mode.

16. The method of claim 11, further comprising reconfiguring a launch sequence of the mobile platforms in response to a received operational parameter comprising at least one of a payload delivery parameter or a deployment parameter.

17. The method of claim 11, further comprising equipping the mobile platforms with the unique identifier such that the unique identifier can be read by a camera on another mobile platform.

18. The method of claim 11, wherein launching the mobile platforms comprises launching the mobile platforms individually spaced apart by at least one time interval.

19. The method of claim 11, wherein determining the stack order of the mobile platforms within the stack comprises at least one of:
analyzing the received identifier data to establish a sequence reflective of the stack order of the mobile platforms;
correlating the established sequence with operational parameters; or
updating the determined stack order based on at least one of newly received identifier data or changes in a mobile platform formation.

20. A method comprising:
receiving, at a ground control station (GCS) in wireless communication with a plurality of stackable mobile platforms through a software defined radio (SDR) network, identifier data transmitted from cameras on the mobile platforms, with the identifier data corresponding to unique identifiers located on surfaces of adjacent mobile platforms within a stacked formation of the mobile platforms;
analyzing the received identifier data utilizing the GCS to establish a sequence reflective of a stack order of the mobile platforms within the stacked formation; and
updating the stack order utilizing the GCS based on at least one of newly received identifier data, a change in the stacked formation of the mobile platforms, an operational parameter, a payload delivery requirement, or a tactical deployment strategy.
